(19) United States
(12) Patent Application Publication
(10) Pub. No.: US 2021/0225168 A1
(43) Pub. Date: Jul. 22, 2021

(54) SYSTEMS AND METHODS FOR ASSISTING OCCUPANTS TO EXIT A PARKED VEHICLE SAFELY

(71) Applicant: Toyota Motor Engineering & Manufacturing North America, Inc., Plano, TX (US)

(72) Inventors: Baik Hoh, Campbell, CA (US); Shalini Keshavamurthy, Sunnyvale, CA (US); Haritha Muralidharan, Santa Clara, CA (US); Yuta Kataoka, Mountain View, CA (US); Rui Guo, San Jose, CA (US); Kentaro Oguchi, Sunnyvale, CA (US)

(21) Appl. No.: 16/748,333

(22) Filed: Jan. 21, 2020

(51) Int. Cl. G08G 1/0962; B60Q 3/70; B60Q 5/00; E05B 77/00; G08G 1/16; G08G 1/01

(52) U.S. Cl. CPC G08G 1/0962; B60Q 3/70; B60Q 5/006; E05B 77/00; E05Y 2900/50; G08G 1/012; E05Y 2400/45; E05Y 2400/44; G08G 1/166

(57) ABSTRACT

Systems and methods for assisting occupants to exit a parked vehicle safely are disclosed herein. One embodiment detects that an other road user has entered a safety monitoring zone; tracks the detected other road user within the safety monitoring zone as the detected other road user approaches the parked vehicle; indicates, to an occupant of the parked vehicle, a first safety condition while a predicted time period until the detected other road user will enter a virtual safety bubble exceeds a predetermined time threshold; indicates, to the occupant of the parked vehicle, a second safety condition and indicates the predicted time period while the predicted time period is greater than zero and less than or equal to the predetermined time threshold; and indicates, to the occupant of the parked vehicle, a third safety condition while the detected other road user is inside the virtual safety bubble.

### TECHNICAL FIELD

The subject matter described herein generally relates to vehicles and, more particularly, to systems and methods for assisting occupants to exit a parked vehicle safely.

### BACKGROUND

Situations sometimes arise in which it is unsafe for an occupant of a vehicle parked on the side of a street or highway to exit the vehicle. Opening a vehicle door at the wrong time can result in a nearby other road user (e.g., pedestrian, cyclist, or vehicle) being struck by the vehicle door as it is opened, or it can result in the other road user running into the open vehicle door. Such an accident can occur not only on the roadway side of the parked vehicle but also on the curb side, depending on the layout of the roadway. For example, in some cities such as San Francisco, there is, along some streets, a lane for cyclists between the closest vehicle lane to the curb and the curb itself. Avoiding this kind of accident can be particularly challenging in a ridesharing context, since ridesharing drivers frequently pull over to the side of the roadway to let off their customers.

### SUMMARY

An example of a system for assisting occupants to exit a parked vehicle safely is presented herein. The system comprises one or more vehicle sensors that output sensor data, one or more processors, and a memory communicably coupled to the one or more processors. The memory stores an other-road-user detection and tracking module including instructions that when executed by the one or more processors cause the one or more processors to detect, based on the sensor data, that an other road user has entered a safety monitoring zone that extends at least behind and to left and right sides of the parked vehicle. The other-road-user detection and tracking module also includes instructions that when executed by the one or more processors cause the one or more processors to track the detected other road user within the safety monitoring zone as the detected other road user approaches the parked vehicle. The memory also stores a safety-status module including instructions that when executed by the one or more processors cause the one or more processors to indicate, to an occupant of the parked vehicle, a first safety condition in which it is safe for the occupant of the parked vehicle to exit the parked vehicle while a predicted time period until the detected other road user will enter a virtual safety bubble exceeds a predetermined time threshold, wherein the virtual safety bubble extends at least behind and to the left and right sides of the parked vehicle and the virtual safety bubble is smaller than the safety monitoring zone in at least a longitudinal dimension. The safety-status module also includes instructions that when executed by the one or more processors cause the one or more processors to indicate, to the occupant of the parked vehicle, a second safety condition in which it is safe for the occupant of the parked vehicle to exit the parked vehicle and to indicate, to the occupant of the parked vehicle, the predicted time period until the detected other road user will enter the virtual safety bubble while the predicted time period until the detected other road user will enter the virtual safety bubble is greater than zero and less than or equal to the predetermined time threshold. The safety-status module also includes instructions that when executed by the one or more processors cause the one or more processors to indicate, to the occupant of the parked vehicle, a third safety condition in which it is unsafe for the occupant of the parked vehicle to exit the parked vehicle while the detected other road user is inside the virtual safety bubble.

Another embodiment is a non-transitory computer-readable medium for assisting occupants to exit a parked vehicle safely and storing instructions that when executed by one or more processors cause the one or more processors to detect, based on sensor data, that an other road user has entered a safety monitoring zone that extends at least behind and to left and right sides of the parked vehicle. The instructions also cause the one or more processors to track the detected other road user within the safety monitoring zone as the detected other road user approaches the parked vehicle. The instructions also cause the one or more processors to indicate, to an occupant of the parked vehicle, a first safety condition in which it is safe for the occupant of the parked vehicle to exit the parked vehicle while a predicted time period until the detected other road user will enter a virtual safety bubble exceeds a predetermined time threshold, wherein the virtual safety bubble extends at least behind and to the left and right sides of the parked vehicle and the virtual safety bubble is smaller than the safety monitoring zone in at least a longitudinal dimension. The instructions also cause the one or more processors to indicate, to the occupant of the parked vehicle, a second safety condition in which it is safe for the occupant of the parked vehicle to exit the parked vehicle and to indicate, to the occupant of the parked vehicle, the predicted time period until the detected other road user will enter the virtual safety bubble while the predicted time period until the detected other road user will enter the virtual safety bubble is greater than zero and less than or equal to the predetermined time threshold. The instructions also cause the one or more processors to indicate, to the occupant of the parked vehicle, a third safety condition in which it is unsafe for the occupant of the parked vehicle to exit the parked vehicle while the detected other road user is inside the virtual safety bubble.

In another embodiment, a method of assisting occupants to exit a parked vehicle safely is disclosed. The method comprises detecting, based on sensor data, that an other road user has entered a safety monitoring zone that extends at least behind and to left and right sides of the parked vehicle. The method also includes tracking the detected other road user within the safety monitoring zone as the detected other road user approaches the parked vehicle. The method also includes indicating, to an occupant of the parked vehicle, a first safety condition in which it is safe for the occupant of the parked vehicle to exit the parked vehicle while a predicted time period until the detected other road user will enter a virtual safety bubble exceeds a predetermined time threshold, wherein the virtual safety bubble extends at least behind and to the left and right sides of the parked vehicle and the virtual safety bubble is smaller than the safety monitoring zone in at least a longitudinal dimension. The method also includes indicating, to the occupant of the parked vehicle, a second safety condition in which it is safe for the occupant of the parked vehicle to exit the parked vehicle and indicating, to the occupant of the parked vehicle, the predicted time period until the detected other road user will enter the virtual safety bubble while the predicted time period until the detected other road user will enter the virtual safety bubble is greater than zero and less than or equal to the predetermined time threshold. The method also includes indicating, to the occupant of the parked vehicle, a third safety condition in which it is unsafe for the occupant of the parked vehicle to exit the parked vehicle while the detected other road user is inside the virtual safety bubble.

### BRIEF DESCRIPTION OF THE DRAWINGS

So that the manner in which the above-recited features of the present disclosure can be understood in detail, a more particular description of the disclosure, briefly summarized above, may be had by reference to the implementations, some of which are illustrated in the appended drawings. It is to be noted, however, that the appended drawings illustrate only possible implementations of this disclosure and are therefore not to be considered limiting of its scope. The disclosure may admit to other implementations.

FIG. 1 illustrates one embodiment of a vehicle within which systems and methods disclosed herein may be implemented.

FIG. 2 illustrates one embodiment of an occupant safe-exit system.

FIG. 3A illustrates a first safety condition in which it is safe for an occupant of a parked vehicle to exit the parked vehicle, in accordance with an illustrative embodiment of the invention.

FIG. 3B illustrates a second safety condition in which it is safe for an occupant of a parked vehicle to exit the parked vehicle, in accordance with an illustrative embodiment of the invention.

FIG. 3C illustrates a third safety condition in which it is unsafe for an occupant of a parked vehicle to exit the parked vehicle, in accordance with an illustrative embodiment of the invention.

FIG. 3D illustrates another example of a third safety condition in which it is unsafe for an occupant of a parked vehicle to exit the parked vehicle due to a detected other road user in the safety monitoring zone exceeding a predetermined speed threshold, in accordance with an illustrative embodiment of the invention.

FIG. 4 illustrates a user interface styled after a traffic light with an accompanying countdown timer, in accordance with an illustrative embodiment of the invention.

FIG. 5 illustrates a scenario in which an occupant safe-exit system computes the predicted time period until a detected other road user will enter a virtual safety bubble based, at least in part, on signal phase and timing information received from a traffic signal.

FIG. 6 is a flowchart of a method of assisting occupants to exit a parked vehicle safely, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

Various embodiments described herein protect the safety of both vehicle occupants and other road users (ORUs) such as pedestrians, bicyclists, motorcyclists, and the drivers of other vehicles. One aspect of these embodiments is detecting that an ORU has entered a predetermined safety monitoring zone proximate to a parked vehicle. For example, in some embodiments, the safety monitoring zone extends at least behind and to the left and right sides of the parked vehicle. A system in the parked vehicle can track an ORU within the safety monitoring zone as the ORU approaches the parked vehicle. Another aspect of the embodiments described herein is a predetermined virtual safety bubble that also extends at least behind and to the left and right sides of the parked vehicle. In some embodiments, the virtual safety bubble is smaller than the safety monitoring zone in at least a longitudinal dimension relative to the parked vehicle. The in-vehicle system can predict a time period until a detected ORU within the safety monitoring zone will enter the virtual safety bubble and dynamically indicate to occupants of the parked vehicle whether it is safe to exit the parked vehicle. The applicable safety condition or status can be indicated visually, through audible sounds, or a combination of the two.

If the predicted time period until the detected ORU will enter the virtual safety bubble is greater than a predetermined time threshold, the system can indicate a first safety condition in which it is safe for an occupant of the parked vehicle to exit the parked vehicle.

If the predicted time period until the detected ORU will enter the virtual safety bubble is greater than zero but less than or equal to the predetermined time threshold mentioned above, the system can indicate a second safety condition in which it is safe for the occupant to exit the parked vehicle. However, in this case, the occupant has less time in which to exit safely. To assist the occupant in exiting safely, the system can indicate, to vehicle occupants, the estimated time remaining until the detected approaching ORU will reach the boundary of the virtual safety bubble. In some embodiments, this is conveyed via a countdown timer.

Once the detected ORU has entered the virtual safety bubble, the system can indicate a third safety condition in which it is unsafe for the occupant to exit the parked vehicle. In some embodiments, additional safety measures can be deployed, such as automatically locking the vehicle doors.

In some embodiments, the safety conditions described above are communicated to occupants of the parked vehicle via a virtual-traffic-light paradigm and, in the case of the second safety condition, a dynamic indication of the predicted time period until a detected ORU will enter the virtual safety bubble is communicated to the occupants (e.g., via a displayed countdown timer or other visual indication of the passage of time). That is, a user interface within the parked vehicle can be styled after a traffic light to indicate the safety conditions. For example, in one embodiment, the first safety condition is indicated by activating a green user-interface element, the second safety condition is indicated by activating a yellow (caution) user-interface element, and the third safety condition is indicated by activating a red (danger) user-interface element. In some embodiments, this virtual-traffic-light paradigm is replaced by or is combined with audible tones or chimes to indicate the safety conditions. For example, in one embodiment, three distinct audible tones or chimes are used in combination with the color-coded user-interface elements discussed above to indicate the three respective safety conditions.

The dimensions, shape, and encompassed area relative to the vehicle of the safety monitoring zone and the virtual safety bubble can vary, depending on the embodiment. In general, the virtual safety bubble (or virtual safety zone) is dimensioned such that an ORU within its boundary that is moving toward the parked vehicle is already too close to the parked vehicle for an occupant to exit safely. For example, in one embodiment, the virtual safety bubble extends 50 meters behind the parked vehicle. The relatively larger safety monitoring zone (e.g., extending 150 meters behind the parked vehicle, in one embodiment) permits the system to track an ORU before it reaches the virtual safety bubble, and the system can estimate the time at which the ORU will enter the smaller virtual safety bubble to provide a granular safety indication (e.g., the first, second, and third safety conditions discussed above) to vehicle occupants. Herein, in describing embodiments employing the virtual-traffic-light user-interface paradigm, the first safety condition will sometimes be referred to as “Condition Green,” the second safety condition as “Condition Yellow,” and the third safety condition as “Condition Red.”

The various embodiments described herein are not limited to rideshare vehicles in their applicability, but they are particularly advantageous for protecting the safety of ridesharing customers and ORUs who encounter parked rideshare vehicles dropping off customers. In some embodiments, a parked vehicle can indicate to ORUs approaching the parked vehicle that a vehicle door is about to be opened. In this context, “about to be opened” means within the next few seconds. For example, in one embodiment the system causes the taillights of the parked vehicle to flash on and off or flicker rapidly to signal that a door is about to be opened.

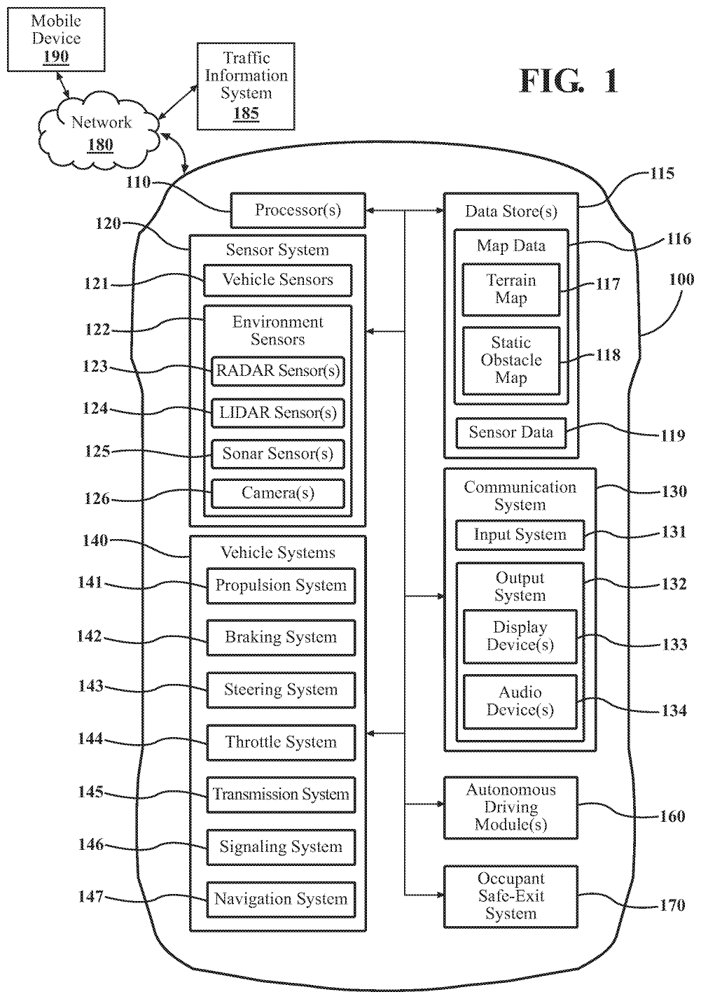

Referring to FIG. 1, an example of a vehicle 100, in which systems and methods disclosed herein can be implemented, is illustrated. The vehicle 100 can include an occupant safe-exit system 170 or components and/or modules thereof. As used herein, a “vehicle” is any form of motorized transport. In one or more implementations, the vehicle 100 can be an automobile. In some implementations, the vehicle 100 may be any other form of motorized transport. In some embodiments, vehicle 100 is capable of operating in a semi-autonomous or fully autonomous mode. The vehicle 100 can include the occupant safe-exit system 170 or capabilities to support or interact with the occupant safe-exit system 170 and thus benefits from the functionality discussed herein. While arrangements will be described herein with respect to automobiles, it will be understood that implementations are not limited to automobiles. Instead, implementations of the principles discussed herein can be applied to any kind of vehicle, as discussed above. Instances of vehicle 100, as used herein, are equally applicable to any device capable of incorporating the systems or methods described herein.

The vehicle 100 also includes various elements. It will be understood that, in various implementations, it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1, including occupant safe-exit system 170. While the various elements are shown as being located within the vehicle 100 in FIG. 1, it will be understood that one or more of these elements can be located external to the vehicle 100. Further, the elements shown may be physically separated by large distances. As shown in FIG. 1, vehicle 100 may communicate with one or more of a traffic information system 185 and a user's mobile device 190 via network 180.

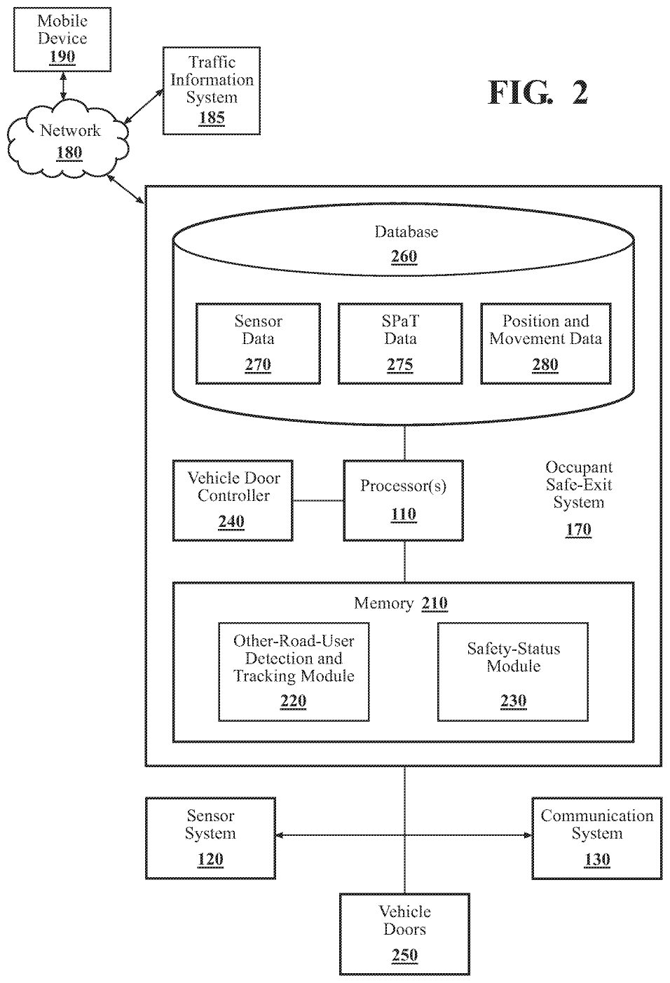

Some of the possible elements of the vehicle 100 are shown in FIG. 1 and will be described in connection with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those skilled in the art, however, will understand that the embodiments described herein may be practiced using various combinations of these elements.

Sensor system 120 can include one or more vehicle sensors 121. Vehicle sensors 121 can include one or more positioning systems such as a dead-reckoning system, a global navigation satellite system (GNSS), or a global positioning system (GPS). Sensor system 120 can also include one or more environment sensors 122. Environment sensors 122 can include RADAR sensor(s) 123, LIDAR sensor(s) 124, sonar sensor(s) 125, and camera(s) 126.

Referring to FIG. 2, one embodiment of the occupant safe-exit system 170 of FIG. 1 is further illustrated. In this embodiment, occupant safe-exit system 170 is shown as including one or more processors 110 from the vehicle 100 of FIG. 1. In general, the one or more processors 110 may be a part of occupant safe-exit system 170, occupant safe-exit system 170 may include one or more separate processors from the one or more processors 110 of the vehicle 100, or occupant safe-exit system 170 may access the one or more processors 110 through a data bus or another communication path, depending on the embodiment.

In one embodiment, memory 210 stores an ORU detection and tracking module 220 and a safety-status module 230. The memory 210 is a random-access memory (RAM), read-only memory (ROM), a hard-disk drive, a flash memory, or other suitable memory for storing the modules 220 and 230. The modules 220 and 230 are, for example, computer-readable instructions that when executed by the one or more processors 110, cause the one or more processors 110 to perform the various functions disclosed herein.

As shown in FIG. 2, occupant safe-exit system 170 can communicate with one or more of a traffic information system 185 and a user's mobile device 190. Examples of a mobile device 190 include, without limitation, a cellular telephone, a smartphone, a personal digital assistant, a tablet computer, and a laptop computer. Occupant safe-exit system 170 can also communicate and interact with sensor system 120 and communication system 130 (refer to FIG. 1). Further, occupant safe-exit system 170 can, via vehicle door controller 240, lock and unlock vehicle doors 250.

In some embodiments, occupant safe-exit system 170 stores sensor data 270 output by sensor system 120 in a database 260. In some embodiments, occupant safe-exit system 170 receives signal phase and timing (SPaT) information from infrastructure (e.g., traffic signals) via network 180. That SPaT data 275 can also be stored in database 260. In some embodiments, occupant safe-exit system 170 receives position and movement data (e.g., data indicating the location and speed) regarding ORUs from traffic information system 185. This position and movement data 280 can also be stored in database 260. How these various kinds of data are used in the context of occupant safe-exit system 170 is explained below.

ORU detection and tracking module 220 generally includes instructions that cause the one or more processors 110 to detect, based on sensor data from sensor system 120, that an ORU has entered a safety monitoring zone that extends at least behind and to left and right sides of a parked vehicle 100. Detecting that an ORU has entered the safety monitoring zone can include the use of a variety of machine-vision techniques such as image segmentation (e.g., semantic segmentation and instance segmentation). ORU detection and tracking module 220 also generally includes instructions that cause the one or more processors 110 to track the detected ORU within the safety monitoring zone as the detected ORU approaches the parked vehicle 100. Tracking a detected ORU can include tracking the trajectory (the path through space as a function of time) of the ORU, estimating the detected ORU's speed, and/or estimating the detected ORU's acceleration. In connection with tracking a detected ORU, ORU detection and tracking module 220 can predict the time period until the detected ORU will enter the virtual safety bubble. That estimated time of the detected ORU's arrival at the boundary of the virtual safety bubble forms at least part of the basis for the indication, to the occupants of the parked vehicle 100, of the applicable safety condition (see the discussion of the first, second, and third safety conditions above) by safety-status module 230. As explained further below, as time passes (i.e., as an ORU continues to travel toward the parked vehicle 100 within the safety monitoring zone), the safety condition can change (e.g., from the first condition to the second, and then to the third). In some embodiments, ORU detection and tracking module 220 can track a plurality of ORUs in the safety monitoring zone simultaneously.

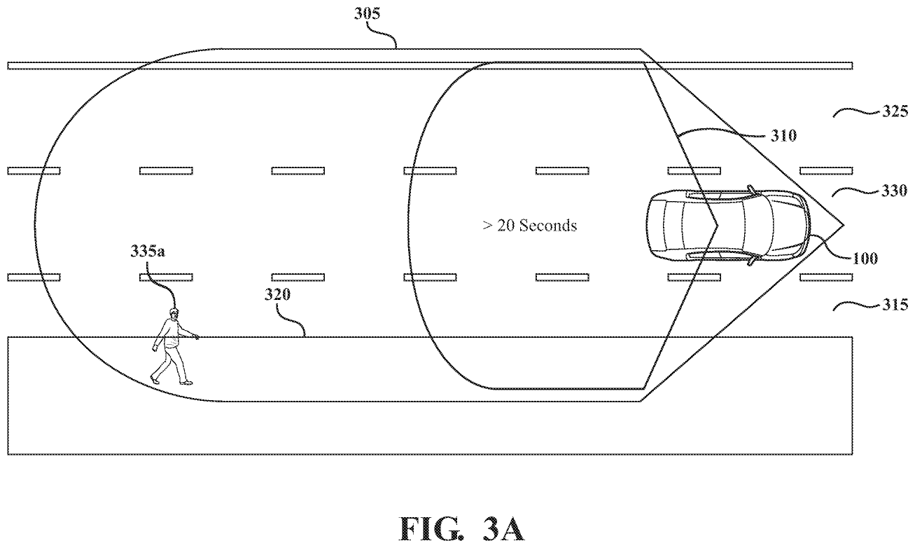

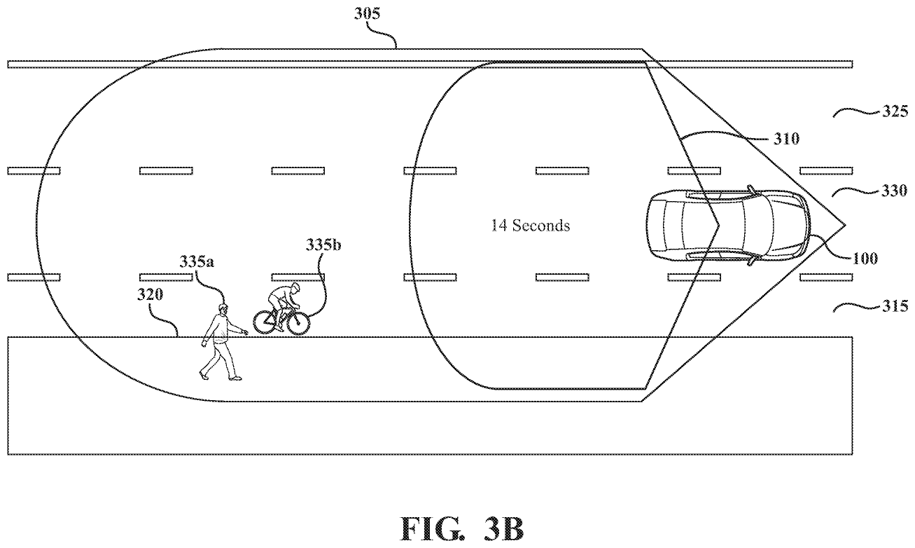

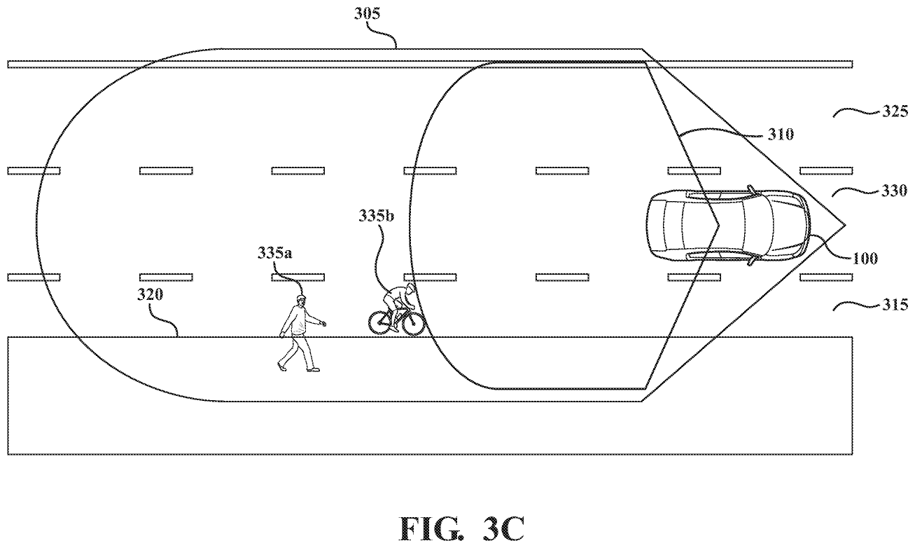

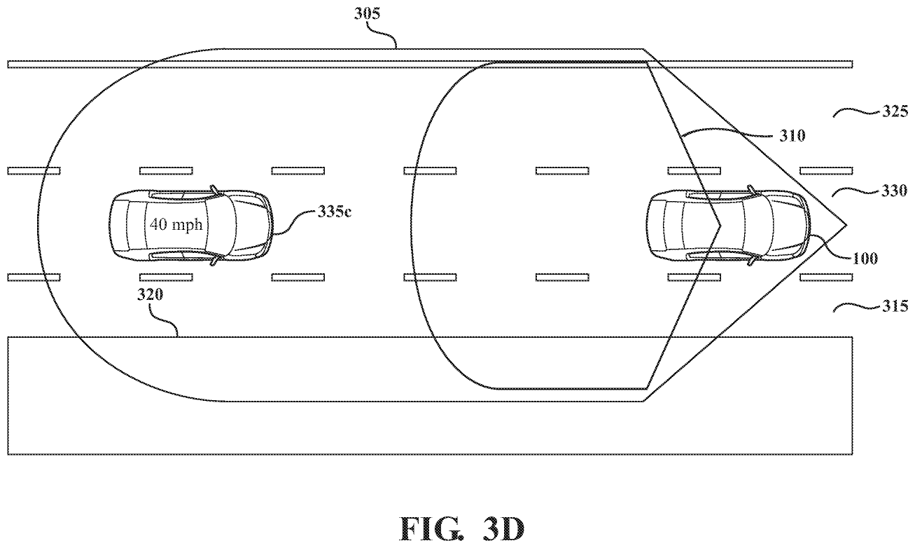

FIG. 3A shows, among other things, one example of a safety monitoring zone 305 encompassing a parked vehicle 100, the majority of the area of safety monitoring zone 305, in this embodiment, extending to the rear and to the left and right sides of the parked vehicle 100. In some embodiments, the safety monitoring zone extends approximately one extra lane width to each side of parked vehicle 100. FIG. 3A also depicts a virtual safety bubble 310. In this embodiment, virtual safety bubble 310 lies within safety monitoring zone 305 and is shorter than safety monitoring zone 305 in the longitudinal direction (the direction of the longitudinal axis of the parked vehicle 100). In this embodiment, virtual safety bubble 310 extends approximately as far to the left and right side of the parked vehicle 100 as safety monitoring zone 305. As mentioned above, in some embodiments, safety monitoring zone 305 extends approximately 150 meters behind the parked vehicle 100, and virtual safety bubble 310 extends approximately 50 meters behind the parked vehicle 100. These dimensions are merely examples, however. In other embodiments, safety monitoring zone 305 and virtual safety bubble 310 can be larger or smaller. FIG. 3A will be discussed further below in connection with safety-status module 230. The sizes of safety monitoring zone 305 and virtual safety bubble 310 can depend, at least in part, on the specific types of environment sensors 122 deployed in vehicle 100. As those skilled in the art are aware, the range of vehicle sensors can vary. Also, in some embodiments, the safety monitoring zone 305 and the virtual safety bubble 310 can include an area extending farther forward (in front of) the vehicle 100 than is depicted in FIG. 3A. Such an embodiment can detect ORUs approaching a vehicle 100 from the front.

Safety-status module 230 generally includes instructions that cause the one or more processors 110 to indicate to an occupant of a parked vehicle 100, in real time, whether it is safe for the occupant to exit the parked vehicle 100. For the purposes of this description, it is “safe” for a vehicle occupant to exit if there is sufficient time for the occupant to exit the vehicle, close the vehicle door, and step to a location that is out of the path of any approaching ORU before any approaching ORU reaches the vehicle. Indicating whether it is safe to exit includes indicating, to the occupant, a first safety condition in which it is safe for the occupant to exit the parked vehicle 100 while the predicted time period until a detected ORU will enter the virtual safety bubble exceeds a predetermined time threshold. In some embodiments, the predetermined time threshold is determined empirically (e.g., through actually measuring the time it takes for a vehicle occupant to exit the vehicle 100 safely under various circumstances in which ORUs are approaching the parked vehicle 100). The predetermined time threshold can also be adjusted dynamically based on one or more of (1) detected traffic density (e.g., based on sensor data from sensor system 120 or information from traffic information system 185) and (2) updated measurements of the duration required for occupants of vehicle 100 to exit vehicle 100 safely in various situations. In one embodiment, the predetermined time threshold is 20 seconds.

Indicating to an occupant of a parked vehicle 100, in real time, whether it is safe for the occupant to exit the parked vehicle 100 can also include indicating, to the occupant, a second safety condition in which it is safe for the occupant to exit the parked vehicle 100 while the predicted time period until the detected other road user will enter the virtual safety bubble is greater than zero and less than or equal to the predetermined time threshold. When the second safety condition is in effect, safety-status module 230 can also indicate, to the occupant, the predicted time period until the detected ORU will enter the virtual safety bubble. In some embodiments, this takes the form of a displayed digital countdown timer (e.g., ticking off the remaining seconds until the detected ORU will enter the virtual safety bubble).

Indicating to an occupant of a parked vehicle 100, in real time, whether it is safe for the occupant to exit the parked vehicle 100 can also include indicating, to the occupant, a third safety condition in which it is unsafe for the occupant to exit the parked vehicle 100 while the detected ORU is inside the virtual safety bubble. In some embodiments, safety-status module 230 can further protect the occupant by automatically locking vehicle doors 250 via vehicle door controller 240. In some embodiments, vehicle doors 250 are locked by default and are unlocked only when the first or second safety condition is in effect. In other embodiments, vehicle doors 250 are automatically locked when the third safety condition is in effect but otherwise remain unlocked (unless the driver of the vehicle or another person chooses to lock them manually).

In some embodiments, in situations in which ORU detection and tracking module 220 detects and tracks multiple ORUs within the safety monitoring zone simultaneously, safety-status module 230 determines which safety condition to indicate to an occupant of a parked vehicle 100 based on which of the detected and tracked ORUs will enter the virtual safety bubble first. The first, second, and third safety conditions are illustrated and discussed further in connection with FIGS. 3A-3D.

Referring again to FIG. 3A, it illustrates a first safety condition in which it is safe for an occupant of a parked vehicle 100 to exit the parked vehicle 100, in accordance with an illustrative embodiment of the invention. In FIG. 3A, a vehicle 100 is parked to permit an occupant (e.g., a ridesharing customer) to exit the vehicle. Occupant safe-exit system 170 in vehicle 100 defines a predetermined safety monitoring zone 305 and a predetermined virtual safety bubble 310, as discussed above. In the particular example shown in FIG. 3A, the street topology is similar to that in some parts of San Francisco, Calif. That is, in addition to left lane 325 and right lane 330, there is a bicycle lane 315 between the right boundary of right lane 330 and the curb 320. In the scenario depicted in FIG. 3A, an ORU 335a (in this case, a pedestrian) is walking in the general direction of the parked vehicle 100. ORU detection and tracking module 220 detects ORU 335a entering safety monitoring zone 305 and begins tracking the trajectory and/or other movement parameters of ORU 335a. In this case, ORU detection and tracking module 220 estimates that it will take ORU 335a more than a predetermined time threshold (in this example, 20 seconds) to enter virtual safety bubble 310. Safety-status module 230 indicates, to the occupant of parked vehicle 100, the first safety condition (safe to exit) discussed above. In this situation, the occupant has ample time during which to exit parked vehicle 100.

Referring to FIG. 3B, it illustrates a second safety condition in which it is safe for an occupant of a parked vehicle 100 to exit the parked vehicle 100, in accordance with an illustrative embodiment of the invention. For the sake of illustration, FIG. 3B is a continuation of the scenario depicted in FIG. 3A. In FIG. B, a brief time has passed during which ORU 335a has walked part of the way toward the parked vehicle 100. In the meantime, another ORU 335b (a more rapidly moving bicyclist) has entered safety monitoring zone 305, and ORU detection and tracking module 220 has been tracking ORU 335b since ORU 335b entered safety monitoring zone 305. As explained above, part of the tracking function that ORU detection and tracking module 220 performs is estimating the time period until a detected ORU enters the virtual safety bubble 310. At the instant in time depicted in FIG. 3B, ORU detection and tracking module 220 estimates that ORU 335b will reach the boundary of virtual safety bubble 310 in less than the predetermined time threshold mentioned above (in this example, 20 seconds) but in greater than zero seconds. Consequently, safety-status module 230 indicates, to the occupant of parked vehicle 100, the second safety condition discussed above. When the second safety condition is in effect, it is safe for the occupant to exit, but, for the sake of safety, it is advisable for the occupant to do so before ORU 335b enters the virtual safety bubble 310. To aid the occupant in exiting safely, safety-status module 230 can indicate the remaining time until ORU 335b will enter the virtual safety bubble 310. In one embodiment, the predicted time period until the detected ORU will enter the virtual safety bubble 310 is displayed on a countdown timer situated somewhere within the interior of vehicle 100. As discussed below, other ways of dynamically indicating the predicted time period are employed in other embodiments. At the instant in time depicted in FIG. 3B, a countdown timer would show 14 seconds remaining.

Referring to FIG. 3C, it illustrates a third safety condition in which it is unsafe for an occupant of a parked vehicle 100 to exit the parked vehicle 100, in accordance with an illustrative embodiment of the invention. For the sake of illustration, FIG. 3C is a continuation of the scenario depicted in FIGS. 3A and 3B. In FIG. 3C, additional time has passed during which the occupant of the parked vehicle 100, for whatever reason, failed to exit before the detected ORU 335b reached the boundary of the virtual safety bubble 310. Once ORU 335b reaches the boundary of virtual safety bubble 310, safety-status module 230 indicates, to the occupant, the third safety condition discussed above. At this point, occupant safe-exit system 170 no longer deems it safe for the occupant to exit the parked vehicle 100. Consequently, in some embodiments, safety-status module 230 may take additional safety measures such as locking vehicle doors 250, as discussed above.

Referring to FIG. 3D, it illustrates another example of the third safety condition in which it is unsafe for an occupant of a parked vehicle 100 to exit the parked vehicle 100 due to a detected ORU (335c) in the safety monitoring zone 305 exceeding a predetermined speed threshold, in accordance with an illustrative embodiment of the invention. FIG. 3D illustrates a special case that can sometimes arise. In this case, an ORU enters safety monitoring zone 305 at an unusually high rate of speed such that there is no opportunity for safety-status module 230 to indicate either the first safety condition (greater than 20 seconds available for safe exit) or the second safety condition (between one and 20 seconds, inclusive, available for safe exit). Instead, safety-status module 230, due to the detected speed (40 miles per hour) of ORU 335c exceeding the predetermined speed threshold (30 miles per hour, in this example), indicates the third safety condition (unsafe to exit). Again, in some embodiments, safety-status module 230 may take additional safety measures such as locking vehicle doors 250, as discussed above.

Other special cases can arise in which the safety condition that safety-status module 230 indicates to the occupant suddenly changes due to changed circumstances. For example, another vehicle might be parked close behind a parked vehicle 100 equipped with occupant safe-exit system 170. Such a stationary ORU, though it is within virtual safety bubble 310, poses no threat to an exiting occupant of the parked vehicle 100. Consequently, in such a case, safety-status module 230 can indicate the first safety condition (safe to exit) to the occupant. However, if the stationary ORU suddenly begins moving (e.g., pulls away from the curb to pass by the parked vehicle 100), safety-status module 230 detects this movement of the ORU and immediately updates the indicated safety condition to the third condition (unsafe to exit).

In another example of a special case, a vehicle 100 equipped with occupant safe-exit system 170 might be parked on the side of the road, and there is an intersection a short distance behind the parked vehicle 100. In such a situation, ORU detection and tracking module 220 might determine that a vehicle approaching the intersection and traveling in the same direction as the parked vehicle 100 prior to its stop will enter the virtual safety bubble 310 in 18 seconds (here, it is assumed that the predetermined time threshold is, again, 20 seconds). In such a situation, safety-status module 230 would indicate the second safety condition to the occupant of the parked vehicle 100 and would also indicate the predicted time period until the detected ORU will enter the virtual safety bubble 310, as discussed above. However, if the approaching ORU (the other vehicle) turns left or right at the intersection, that ORU no longer poses a danger to an occupant in the parked vehicle 100. In such a case, safety-status module 230 can immediately change the indicated safety condition to the first condition, assuming that no other ORUs have entered the safety monitoring zone 305 in the meantime and will enter the virtual safety bubble 310 in less than the predetermined time threshold.

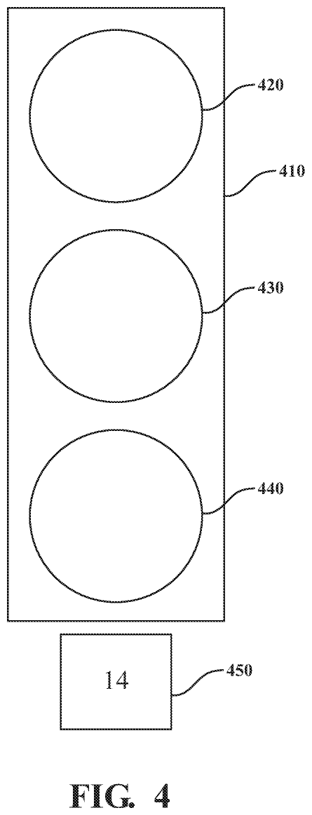

The manner in which safety-status module 230 indicates, to a vehicle occupant, the various safety conditions discussed above varies depending on the particular embodiment. One example of a user interface for indicating the current safety condition is illustrated in FIG. 4.

Referring to FIG. 4, it illustrates a user interface 410 styled after a traffic light accompanied by a countdown timer 450, in accordance with an illustrative embodiment of the invention. The user interface 410 and countdown timer 450 can be deployed in a variety of ways and in a variety of locations within vehicle 100. In some embodiments, user interface 410 and countdown timer 450 can be displayed in multiple locations within vehicle 100 simultaneously (e.g., different locations that are visible to front-seat and back-seat occupants). Examples of such locations include door panels, the vicinity of the rearview mirror, the back of a front seat, and side windows (in this embodiment, the side windows act as a display). However or wherever user interface 410 is displayed, it can appear to an occupant much like a standard traffic light. In the embodiment shown in FIG. 4, it includes a red user-interface element 420 corresponding to the third safety condition (or Condition Red), a yellow user-interface element 430 corresponding to the second safety condition (or Condition Yellow), and a green user-interface element 440 corresponding to the first safety condition (or Condition Green). User interface 410 can be implemented using actual red, yellow, and green lights, or user interface 410 with its colored user-interface elements 420, 430, and 440 can be presented on a color display (e.g., an LCD display) or a window (e.g., a side window, as mentioned above).

As explained above, countdown timer 450 displays, in real time, the predicted time period until a detected ORU will enter the virtual safety bubble 310. In other words, countdown timer 450 displays the remaining time (e.g., in seconds) until the detected ORU reaches the boundary of the virtual safety bubble 310. Countdown timer 450 can be displayed in a variety of ways using a variety of different kinds of hardware. In some embodiments, countdown timer 450 is displayed in conjunction with user interface 410. In other embodiments that do not employ the traffic-light paradigm depicted in FIG. 4, countdown timer 450 can still be provided to guide an occupant of vehicle 100 in exiting safely. In some embodiments, safety-status module 230 causes countdown timer 450 to be displayed only when the second safety condition (Condition Yellow, if a user interface such as user interface 410 is deployed) is in effect. Though some embodiments include a digital countdown timer 450, as depicted in FIG. 4, other embodiments employ a different indication of the predicted time period until a detected ORU will enter the virtual safety bubble 310, when the second safety condition is in effect. Examples include, without limitation, a progress bar, a shrinking bar, a virtual analog timer with a moving second hand, a gradually dimming light, a virtual-hour-glass icon in which the “sand” runs out, an audible countdown, etc.

In some embodiments, safety-status module 230 makes use of audible sounds (tones, beeps, chimes, sound effects, etc.) to indicate, to an occupant of a parked vehicle 100, the respective safety conditions discussed above. In one embodiment, safety-status module 230 uses a distinct sound for each of the three safety conditions. These audible sounds can be used in place of a visual indication of the safety conditions, or they can be used in addition to a visual user interface such as the user interface 410 depicted in FIG. 4.

In some embodiments, safety-status module 230 includes instructions that cause the one or more processors 110 to provide an occupant with an audible countdown for at least a portion of the time period that the second safety condition (Condition Yellow, in embodiments that include the traffic-light paradigm) is in effect. The audible countdown can be coordinated or synchronized with the countdown displayed by countdown timer 450, in embodiments that include a countdown timer 450. For example, in one embodiment, safety-status module 230 activates an audible countdown for the last ten seconds before the third safety condition (Condition Red, in embodiments that include the traffic-light paradigm) takes effect. The audible countdown can be provided via audio device(s) 134 of communication system 130.

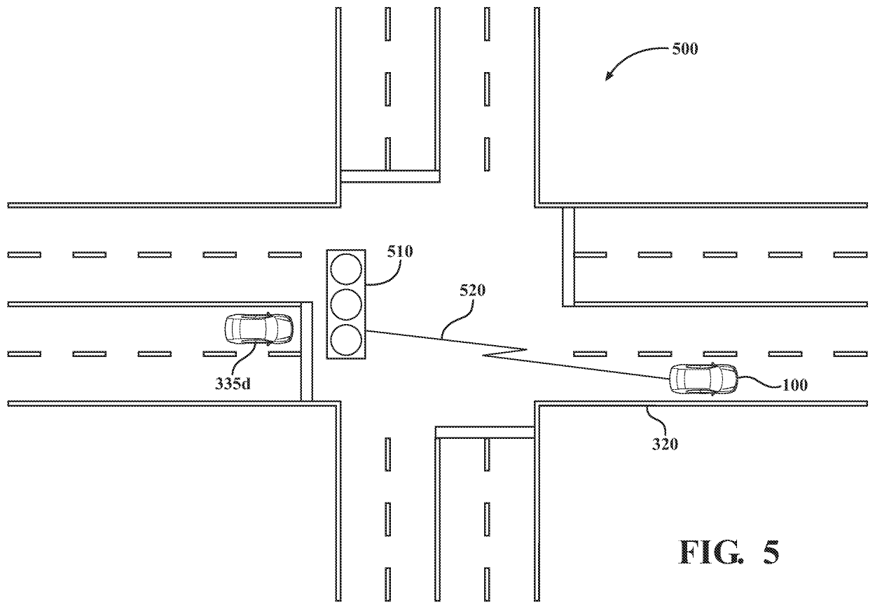

FIG. 5 illustrates a scenario in which an occupant safe-exit system 170 computes the predicted time period until a detected ORU will enter a virtual safety bubble 310 based, at least in part, on signal phase and timing (SPaT) information received from a traffic signal. In FIG. 5, vehicle 100 is parked along curb 320 shortly beyond an intersection 500. ORU 335d (the driver of another vehicle) is waiting for a red light displayed by traffic signal 510. In this embodiment, vehicle 100 can receive, via wireless communication link 520, SPaT information from traffic signal 510 informing safety-status module 230 how long it will be until the red light will change to green. If that time exceeds the predetermined time threshold, as discussed above, safety-status module 230 can indicate the first safety condition. If that time is between one second and the predetermined time threshold, inclusive, safety-status module 230 can indicate the second safety condition and indicate the predicted time period until the detected ORU 335d will enter the virtual safety bubble 310, as discussed above. In estimating the time at which the ORU will enter the virtual safety bubble 310 of the parked vehicle 100, ORU detection and tracking module 220 can take into account the time it will take for the ORU 335d to accelerate to an expected speed from a dead stop. One advantage of an embodiment that includes the use of SPaT data 275 is that it reduces the likelihood that occupant safe-exit system 170 will need to suddenly update the safety condition and/or the indication of the predicted time period until a detected ORU will enter the virtual safety bubble 310, when the second safety condition is in effect.

In some embodiments, ORU detection and tracking module 220 may receive supplemental information about the position (e.g., GPS coordinates) and movement (e.g., speed and/or acceleration) of ORUs from a traffic information system 185. Such a traffic information system may include a plurality of sensors distributed along the roadway and at intersections, roadside units (RSUs), and one or more cloud servers that collect and disseminate information about the position and movement of road users in a particular geographic region (e.g., a city or portion of a city).

In some embodiments, safety-status module 230 includes instructions that cause the one or more processors 110 to indicate to one or more ORUs that a door of a parked vehicle 100 is about to be opened (this could apply when either the first or the second safety condition is in effect). How this is indicated to ORUs near a vehicle 100 can vary, depending on the embodiment. In one embodiment, the taillights of vehicle 100 are flashed on and off or flickered rapidly. In another embodiment, one or more special lights separate from the taillights are activated. In yet another embodiment, an audible sound (possibly a spoken warning such as, “A door is about to open”) is emitted. In some embodiments, a visual warning (e.g., one or more lights) is combined with an audible sound or warning.

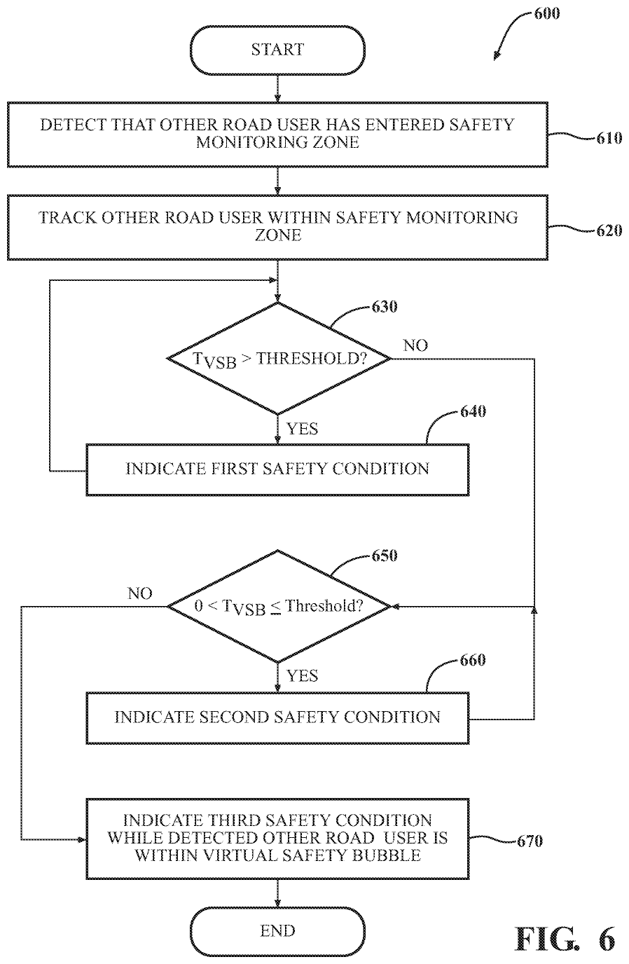

FIG. 6 is a flowchart of a method 600 of assisting occupants to exit a parked vehicle safely, in accordance with an illustrative embodiment of the invention. Method 600 will be discussed from the perspective of occupant safe-exit system 170 in FIG. 2. While method 600 is discussed in combination with occupant safe-exit system 170, it should be appreciated that method 600 is not limited to being implemented within occupant safe-exit system 170, but occupant safe-exit system 170 is instead one example of a system that may implement method 600. Note that some embodiments include additional actions that are not shown in FIG. 6. Those additional actions are discussed below after the discussion of FIG. 6.

At block 610, ORU detection and tracking module 220 detects, based on sensor data 270, that an ORU has entered a safety monitoring zone 305 that extends at least behind and to left and right sides of the parked vehicle 100. As discussed above, detecting that an ORU has entered the safety monitoring zone 305 can include the use of a variety of machine-vision techniques such as image segmentation (e.g., semantic segmentation and instance segmentation).

At block 620, ORU detection and tracking module 220 tracks the detected ORU within the safety monitoring zone 305 as the detected other road user approaches the parked vehicle 100. As discussed above, tracking a detected ORU can include tracking the trajectory (the path through space as a function of time) of the ORU, estimating the detected ORU's speed, and/or estimating the detected ORU's acceleration. In connection with tracking a detected ORU, ORU detection and tracking module 220 can also predict the time period until the detected ORU will enter the virtual safety bubble 310. This estimated time of the detected ORU's arrival at the boundary of the virtual safety bubble 310 forms at least part of the basis for the indication, to the occupants of the parked vehicle 100, of the applicable safety condition by safety-status module 230.

At block 630, if the predicted time period until the detected ORU will enter the virtual safety bubble 310 (TvsB in FIG. 6) exceeds a predetermined time threshold, safety-status module 230, at block 640, indicates the first safety condition to an occupant of the parked vehicle 100. Otherwise, control proceeds to block 650. As discussed above, the first safety condition is one in which an occupant of the parked vehicle 100 can safely exit.

At block 650, if the predicted time period until the detected ORU will enter the virtual safety bubble 310 (TvsB in FIG. 6) is greater than zero and less than or equal to the predetermined time threshold, safety-status module 230, at block 660, indicates the second safety condition to the occupant of the parked vehicle 100. As discussed above, it is safe for the occupant to exit the parked vehicle 100 while the second safety condition is in effect, but, due to the narrower time window as a tracked ORU approaches the parked vehicle 100, safety-status module 230 further assists the occupant in exiting parked vehicle 100 safely by indicating, to the occupant, the predicted time period until the detected ORU will enter the virtual safety bubble 310. As discussed above, this can be done in a variety of ways, but, in one embodiment, the remaining time until the detected ORU enters the virtual safety bubble 310 is displayed dynamically on a countdown timer 450. If the condition in block 650 is not satisfied, control proceeds to block 670.

At block 670, safety-status module 230 responds to the detected ORU having entered the virtual safety bubble 310 by indicating, to the occupant of the parked vehicle 100, the third safety condition—a condition in which it is unsafe for the occupant to exit the parked vehicle 100.

As discussed above, in some embodiments safety-status module 230 indicates the first, second, and third safety conditions via a user interface 410 that is styled after a traffic light having familiar green, yellow, and red user-interface elements, respectively. Further, when the second safety condition is in effect, the predicted time period until a detected ORU enters the virtual safety bubble 310 can be indicated to vehicle occupants (e.g., as a countdown timer 450, in some embodiments). In some embodiments, safety-status module 230 indicating, to the occupant, the predicted time period until a detected ORU enters the virtual safety bubble 310 includes an audible countdown. In embodiments that also employ a countdown timer 450, the audible countdown can be coordinated or synchronized with the countdown timer 450. In some of those embodiments, the audible countdown accompanies the visual countdown timer 450 for only a portion of the period after the second safety condition takes effect (e.g., for the last ten seconds before the detected ORU enters the boundary of the virtual safety bubble 310).

As also discussed above, in some embodiments, safety-status module 230 makes use of audible sounds (tones, beeps, chimes, sound effects, etc.) to indicate, to an occupant of a parked vehicle 100, the respective safety conditions discussed above. In one embodiment, safety-status module 230 uses a distinct sound for each of the three safety conditions. These audible sounds can be used in place of a visual indication of the safety conditions, or they can be used in addition to a visual user interface such as the traffic-light-style user interface 410 depicted in FIG. 4.

In other embodiments, method 600 can be expanded to include additional actions. For example, in some embodiments, safety-status module 230 can further protect the occupant of a parked vehicle 100 by automatically locking vehicle doors 250 via vehicle door controller 240. As discussed above, in some embodiments, vehicle doors 250 are locked by default and are unlocked only when the first or second safety condition is in effect. In other embodiments, vehicle doors 250 are automatically locked when the third safety condition is in effect but otherwise remain unlocked (unless the driver of the vehicle or another person chooses to lock them manually).

As discussed above, the predetermined time threshold can be adjusted dynamically based on one or more of (1) detected traffic density (e.g., based on sensor data from sensor system 120 or information from traffic information system 185) and (2) updated measurements of the duration required for occupants of vehicle 100 to exit vehicle 100 safely in various situations. In one embodiment, the predetermined time threshold is 20 seconds.

As discussed above, in some embodiments, occupant safe-exit system 170 receives signal phase and timing (SPaT) information from infrastructure (e.g., traffic signals) via network 180. In some embodiments, occupant safe-exit system 170 receives position and movement data (e.g., data indicating the location and speed) regarding ORUs from traffic information system 185. ORU detection and tracking module 220 can base its prediction of the time period until a detected ORU will enter the virtual safety bubble 310, at least in part, on the received SPaT data 275, the received position and movement data 280, or both.

As discussed above, in one embodiment, safety-status module 230 includes instructions that cause the one or more processors 110 to indicate, to the occupant of a parked vehicle 100, the third safety condition (not safe to exit) when the tracked speed of a detected ORU within the safety monitoring zone 305 exceeds a predetermined speed threshold.

As also discussed above, in some embodiments, safety-status module 230 includes instructions that cause the one or more processors 110 to indicate to one or more ORUs that a door of a parked vehicle 100 is about to be opened (this could apply when either the first or the second safety condition is in effect).

As also discussed above, in some embodiments, safety-status module 230 includes instructions that cause the one or more processors 110 to indicate, to an occupant of a parked vehicle 100, the first safety condition while a detected ORU remains stationary within the virtual safety bubble 310. In those embodiments, if the detected stationary ORU suddenly begins moving, safety-status module 230 indicates the third safety condition (unsafe to exit) to the occupant.

Throughout much of the above description, the singular “occupant” has been used for simplicity. The various embodiments and features discussed herein are equally applicable when there are a plurality of occupants in a parked vehicle 100 who desire to exit the vehicle. As discussed above, in some embodiments, vehicle 100 is a rideshare vehicle, and one or more occupants of the vehicle 100 are ridesharing customers. In some embodiments, vehicle 100 is an autonomous rideshare vehicle.

FIG. 1 will now be discussed in full detail as an example vehicle environment within which the systems and methods disclosed herein may be implemented. In some instances, the vehicle 100 can be configured to switch selectively between an autonomous mode, one or more semi-autonomous operational modes, and/or a manual mode. Such switching, also referred to as handover when transitioning to a manual mode, can be implemented in a suitable manner, now known or later developed. “Manual mode” means that all of or a majority of the navigation and/or maneuvering of the vehicle is performed according to inputs received from a user (e.g., human driver/operator).

In one or more implementations, the vehicle 100 can be an autonomous vehicle. As used herein, “autonomous vehicle” refers to a vehicle that operates in an autonomous mode. “Autonomous mode” refers to navigating and/or maneuvering a vehicle along a travel route using one or more computing devices to control the vehicle with minimal or no input from a human driver/operator. In one implementation, the vehicle 100 is configured with one or more semi-autonomous operational modes in which one or more computing devices perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route. Thus, in one or more implementations, the vehicle 100 operates autonomously according to a particular defined level of autonomy.

The vehicle 100 can include one or more processors 110. In one or more arrangements, the one or more processors 110 can be a main processor of the vehicle 100. For instance, the one or more processors 110 can be an electronic control unit (ECU). The vehicle 100 can include one or more data stores 115 for storing one or more types of data. The data store(s) 115 can include volatile and/or non-volatile memory. Examples of suitable data stores 115 include RAM, flash memory, ROM, PROM (Programmable Read-Only Memory), EPROM, EEPROM (Electrically Erasable Programmable Read-Only Memory), registers, magnetic disks, optical disks, hard drives, or any other suitable storage medium, or any combination thereof. The data store(s) 115 can be a component(s) of the one or more processors 110, or the data store(s) 115 can be operatively connected to the one or more processors 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. In one or more arrangement, the map data 116 can include one or more terrain maps 117. The terrain map(s) 117 can include information about the ground, terrain, roads, surfaces, and/or other features of one or more geographic areas. In one or more arrangement, the map data 116 can include one or more static obstacle maps 118. The static obstacle map(s) 118 can include information about one or more static obstacles located within one or more geographic areas.

The one or more data stores 115 can include sensor data 119. In this context, “sensor data” means any information about the sensors that a vehicle is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120. As discussed above, in some embodiments, vehicle 100 can receive sensor data from other connected vehicles, from devices associated with ORUs, or both.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can function independently from each other. Alternatively, two or more of the sensors can work in combination with each other. In such a case, the two or more sensors can form a sensor network. The sensor system 120 and/or the one or more sensors can be operatively connected to the one or more processors 110, the data store(s) 115, and/or another element of the vehicle 100 (including any of the elements shown in FIG. 1).

The sensor system 120 can include any suitable type of sensor. Various examples of different types of sensors will be described herein. However, it will be understood that the implementations are not limited to the particular sensors described. The sensor system 120 can include one or more vehicle sensors 121. The vehicle sensors 121 can detect, determine, and/or sense information about the vehicle 100 itself, including the operational status of various vehicle components and systems.

In one or more arrangements, the vehicle sensors 121 can be configured to detect, and/or sense position and/orientation changes of the vehicle 100, such as, for example, based on inertial acceleration. In one or more arrangements, the vehicle sensors 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensors 121 can be configured to detect, and/or sense one or more characteristics of the vehicle 100. In one or more arrangements, the vehicle sensors 121 can include a speedometer to determine a current speed of the vehicle 100.

Alternatively, or in addition, the sensor system 120 can include one or more environment sensors 122 configured to acquire, and/or sense driving environment data. “Driving environment data” includes any data or information about the external environment in which a vehicle is located or one or more portions thereof. For example, the one or more environment sensors 122 can be configured to detect, quantify, and/or sense obstacles in at least a portion of the external environment of the vehicle 100 and/or information/data about such obstacles. The one or more environment sensors 122 can be configured to detect, measure, quantify, and/or sense other things in at least a portion the external environment of the vehicle 100, such as, for example, nearby vehicles, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. Moreover, the sensor system 120 can include operator sensors that function to track or otherwise monitor aspects related to the driver/operator of the vehicle 100. However, it will be understood that the implementations are not limited to the particular sensors described. As an example, in one or more arrangements, the sensor system 120 can include one or more radar sensors 123, one or more LIDAR sensors 124, one or more sonar sensors 125, and/or one or more cameras 126.

The vehicle 100 can further include a communication system 130. The communication system 130 can include one or more components configured to facilitate communication between the vehicle 100 and one or more communication sources. Communication sources, as used herein, refers to people or devices with which the vehicle 100 can communicate with, such as external networks, computing devices, operator or occupants of the vehicle 100, or others. As part of the communication system 130, the vehicle 100 can include an input system 131. An “input system” includes any device, component, system, element or arrangement or groups thereof that enable information/data to be entered into a machine. In one or more examples, the input system 131 can receive an input from a vehicle occupant (e.g., a driver or a passenger). The vehicle 100 can include an output system 132. An “output system” includes any device, component, or arrangement or groups thereof that enable information/data to be presented to the one or more communication sources (e.g., a person, a vehicle passenger, etc.). The communication system 130 can further include specific elements which are part of or can interact with the input system 131 or the output system 132, such as one or more display device(s) 133, and one or more audio device(s) 134 (e.g., speakers and microphones).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or combinations thereof, now known or later developed.

The one or more processors 110 and/or the autonomous driving module(s) 160 can be operatively connected to communicate with the various vehicle systems 140 and/or individual components thereof. For example, returning to FIG. 1, the one or more processors 110 and/or the autonomous driving module(s) 160 can be in communication to send and/or receive information from the various vehicle systems 140 to control the movement, speed, maneuvering, heading, direction, etc. of the vehicle 100. The one or more processors 110 and/or the autonomous driving module(s) 160 may control some or all of these vehicle systems 140 and, thus, may be partially or fully autonomous.

The vehicle 100 can include one or more modules, at least some of which are described herein. The modules can be implemented as computer-readable program code that, when executed by a processor 110, implement one or more of the various processes described herein. The processor 110 can be a device, such as a CPU, which is capable of receiving and executing one or more threads of instructions for the purpose of performing a task. One or more of the modules can be a component of the one or more processors 110, or one or more of the modules can be executed on and/or distributed among other processing systems to which the one or more processors 110 is operatively connected. The modules can include instructions (e.g., program logic) executable by one or more processors 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

In some implementations, the vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine the position and velocity of the vehicle 100. The autonomous driving module(s) 160 can determine the location of obstacles, or other environmental features including traffic signs, trees, shrubs, neighboring vehicles, pedestrians, etc.

The autonomous driving module(s) 160 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g., one or more of vehicle systems 140). The noted functions and methods will become more apparent with a further discussion of the figures.

Detailed implementations are disclosed herein. However, it is to be understood that the disclosed implementations are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various implementations are shown in FIGS. 1-6, but the implementations are not limited to the illustrated structure or application.

The flowcharts and block diagrams in the figures illustrate the architecture, functionality, and operation of possible implementations of systems, methods, and computer program products according to various implementations. In this regard, each block in the flowcharts or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can be executed substantially concurrently, or the blocks can sometimes be executed in the reverse order, depending upon the functionality involved.

The systems, components and/or methods described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or methods also can be embedded in a computer-readable storage, such as a computer program product or other data programs storage device, readable by a machine, tangibly embodying a program of instructions executable by the machine to perform methods and methods described herein. These elements also can be embedded in an application product which comprises all the features enabling the implementation of the methods described herein and, which when loaded in a processing system, is able to carry out these methods.

Furthermore, arrangements described herein can take the form of a computer program product embodied in one or more computer-readable media having computer-readable program code embodied or embedded, such as stored thereon. Any combination of one or more computer-readable media can be utilized. The computer-readable medium can be a computer-readable signal medium or a computer-readable storage medium. The phrase “computer-readable storage medium” means a non-transitory storage medium. A computer-readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a RAM, a ROM, an EPROM or Flash memory, an optical fiber, a portable compact disc read-only memory (CD-ROM), a digital versatile disc (DVD), an optical storage device, a magnetic storage device, or any suitable combination of the foregoing. In the context of this document, a computer-readable storage medium can be any tangible medium that can contain, or store a program for use by, or in connection with, an instruction execution system, apparatus, or device.

Program code embodied on a computer-readable medium can be transmitted using any appropriate medium, including but not limited to wireless, wireline, optical fiber, cable, RF, etc., or any suitable combination of the foregoing. Computer program code for carrying out operations for aspects of the present arrangements can be written in any combination of one or more programming languages, including an object-oriented programming language such as Java™ Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a LAN or a WAN, or the connection can be made to an external computer (for example, through the Internet using an Internet Service Provider).

In the description above, certain specific details are outlined in order to provide a thorough understanding of various implementations. However, one skilled in the art will understand that the invention may be practiced without these details. In other instances, well-known structures have not been shown or described in detail to avoid unnecessarily obscuring descriptions of the implementations. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one or more implementations” or “an implementation” means that a particular feature, structure or characteristic described in connection with the implementation is included in at least one or more implementations. Thus, the appearances of the phrases “in one or more implementations” or “in an implementation” in various places throughout this specification are not necessarily all referring to the same implementation. Furthermore, the particular features, structures, or characteristics may be combined in any suitable manner in one or more implementations. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings (such as “Background” and “Summary”) and sub-headings used herein are intended only for general organization of topics within the present disclosure and are not intended to limit the disclosure of the technology or any aspect thereof. The recitation of multiple implementations having stated features is not intended to exclude other implementations having additional features, or other implementations incorporating different combinations of the stated features. As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an implementation can or may comprise certain elements or features does not exclude other implementations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an implementation or particular system is included in at least one or more implementations or aspect. The appearances of the phrase “in one aspect” (or variations thereof) are not necessarily referring to the same aspect or implementation. It should also be understood that the various method steps discussed herein do not have to be carried out in the same order as depicted, and not each method step is required in each aspect or implementation.

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one as or more than one. The term “plurality,” as used herein, is defined as two or more than two. The term “another,” as used herein, is defined as at least a second or more. The terms “including” and/or “having,” as used herein, are defined as including (i.e., open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC).

The preceding description of the implementations has been provided for purposes of illustration and description. It is not intended to be exhaustive or to limit the disclosure. Individual elements or features of a particular implementation are generally not limited to that particular implementation, but, where applicable, are interchangeable and can be used in a selected implementation, even if not specifically shown or described. The same may also be varied in many ways. Such variations should not be regarded as a departure from the disclosure, and all such modifications are intended to be included within the scope of the disclosure.

While the preceding is directed to implementations of the disclosed devices, systems, and methods, other and further implementations of the disclosed devices, systems, and methods can be devised without departing from the basic scope thereof. The scope thereof is determined by the claims that follow.

What is claimed is:

1. A system for assisting occupants to exit a parked vehicle safely, the system comprising:
one or more vehicle sensors that output sensor data;
one or more processors; and
a memory communicably coupled to the one or more processors and storing:
an other-road-user detection and tracking module including instructions that when executed by the one or more processors cause the one or more processors to:
detect, based on the sensor data, that an other road user has entered a safety monitoring zone that extends at least behind and to left and right sides of the parked vehicle; and
track the detected other road user within the safety monitoring zone as the detected other road user approaches the parked vehicle; and
a safety-status module including instructions that when executed by the one or more processors cause the one or more processors to:
indicate, to an occupant of the parked vehicle, a first safety condition in which it is safe for the occupant of the parked vehicle to exit the parked vehicle while a predicted time period until the detected other road user will enter a virtual safety bubble exceeds a predetermined time threshold, wherein the virtual safety bubble extends at least behind and to the left and right sides of the parked vehicle and the virtual safety bubble is smaller than the safety monitoring zone in at least a longitudinal dimension;
indicate, to the occupant of the parked vehicle, a second safety condition in which it is safe for the occupant of the parked vehicle to exit the parked vehicle and to indicate, to the occupant of the parked vehicle, the predicted time period until the detected other road user will enter the virtual safety bubble while the predicted time period until the detected other road user will enter the virtual safety bubble is greater than zero and less than or equal to the predetermined time threshold; and
indicate, to the occupant of the parked vehicle, a third safety condition in which it is unsafe for the occupant of the parked vehicle to exit the parked vehicle while the detected other road user is inside the virtual safety bubble.

2. The system of claim 1, wherein the parked vehicle is a rideshare vehicle and the occupant of the parked vehicle is a ridesharing customer.

3. The system of claim 1, further comprising a user interface styled after a traffic light and a countdown timer in an interior of the parked vehicle, wherein:
the instructions in the safety-status module to indicate, to the occupant of the parked vehicle, the first safety condition include instructions to activate a green user-interface element of the user interface;
the instructions in the safety-status module to indicate, to the occupant of the parked vehicle, the second safety condition include instructions to activate a yellow user-interface element of the user interface;
the instructions in the safety-status module to indicate, to the occupant of the parked vehicle, the third safety condition include instructions to activate a red user-interface element of the user interface; and
the instructions in the safety-status module to indicate, to the occupant of the parked vehicle, the predicted time period until the detected other road user will enter the virtual safety bubble include instructions to display the predicted time period on the countdown timer.

4. The system of claim 1, wherein the safety-status module includes instructions to adjust the predetermined time threshold based on one or more of:
detected traffic density; and
a measured duration required for occupants of the parked vehicle to exit the parked vehicle safely.

5. The system of claim 1, wherein the other-road-user detection and tracking module includes instructions to compute the predicted time period until the detected other road user will enter the virtual safety bubble based, at least in part, on one of:
signal phase and timing information for a traffic signal received over a network; and
position and movement data pertaining to the detected other road user received over the network from a traffic information system.

6. The system of claim 1, wherein the safety-status module includes further instructions to indicate, to the occupant of the parked vehicle, the third safety condition when a tracked speed of the detected other road user exceeds a predetermined speed threshold.

7. The system of claim 1, wherein the safety-status module includes further instructions to indicate to other road users that a door of the parked vehicle is about to be opened, when one of the first safety condition and the second safety condition is in effect.

8. A non-transitory computer-readable medium for assisting occupants to exit a parked vehicle safely and storing instructions that when executed by one or more processors cause the one or more processors to:
detect, based on sensor data, that an other road user has entered a safety monitoring zone that extends at least behind and to left and right sides of the parked vehicle;
track the detected other road user within the safety monitoring zone as the detected other road user approaches the parked vehicle;
indicate, to an occupant of the parked vehicle, a first safety condition in which it is safe for the occupant of the parked vehicle to exit the parked vehicle while a predicted time period until the detected other road user will enter a virtual safety bubble exceeds a predetermined time threshold, wherein the virtual safety bubble extends at least behind and to the left and right sides of the parked vehicle and the virtual safety bubble is smaller than the safety monitoring zone in at least a longitudinal dimension;
indicate, to the occupant of the parked vehicle, a second safety condition in which it is safe for the occupant of the parked vehicle to exit the parked vehicle and to indicate, to the occupant of the parked vehicle, the predicted time period until the detected other road user will enter the virtual safety bubble while the predicted time period until the detected other road user will enter the virtual safety bubble is greater than zero and less than or equal to the predetermined time threshold; and
indicate, to the occupant of the parked vehicle, a third safety condition in which it is unsafe for the occupant of the parked vehicle to exit the parked vehicle while the detected other road user is inside the virtual safety bubble.

9. The non-transitory computer-readable medium of claim 8, wherein:
the instructions to indicate, to the occupant of the parked vehicle, the first safety condition include instructions to activate a green user-interface element of a user interface that is styled after a traffic light within the parked vehicle;
the instructions to indicate, to the occupant of the parked vehicle, the second safety condition include instructions to activate a yellow user-interface element of the user interface;
the instructions to indicate, to the occupant of the parked vehicle, the third safety condition include instructions to activate a red user-interface element of the user interface; and
the instructions to indicate, to the occupant of the parked vehicle, the predicted time period until the detected other road user will enter the virtual safety bubble include instructions to display the predicted time period on a countdown timer.

10. A method of assisting occupants to exit a parked vehicle safely, the method comprising:
detecting, based on sensor data, that an other road user has entered a safety monitoring zone that extends at least behind and to left and right sides of the parked vehicle;
tracking the detected other road user within the safety monitoring zone as the detected other road user approaches the parked vehicle;
indicating, to an occupant of the parked vehicle, a first safety condition in which it is safe for the occupant of the parked vehicle to exit the parked vehicle while a predicted time period until the detected other road user will enter a virtual safety bubble exceeds a predetermined time threshold, wherein the virtual safety bubble extends at least behind and to the left and right sides of the parked vehicle and the virtual safety bubble is smaller than the safety monitoring zone in at least a longitudinal dimension;
indicating, to the occupant of the parked vehicle, a second safety condition in which it is safe for the occupant of the parked vehicle to exit the parked vehicle and indicating, to the occupant of the parked vehicle, the predicted time period until the detected other road user will enter the virtual safety bubble while the predicted time period until the detected other road user will enter the virtual safety bubble is greater than zero and less than or equal to the predetermined time threshold; and
indicating, to the occupant of the parked vehicle, a third safety condition in which it is unsafe for the occupant of the parked vehicle to exit the parked vehicle while the detected other road user is inside the virtual safety bubble.

11. The method of claim 10, wherein:
indicating, to the occupant of the parked vehicle, the first safety condition includes activating a green user-interface element of a user interface styled after a traffic light within the parked vehicle;
indicating, to the occupant of the parked vehicle, the second safety condition includes activating a yellow user-interface element of the user interface;
indicating, to the occupant of the parked vehicle, the third safety condition includes activating a red user-interface element of the user interface; and
indicating, to the occupant of the parked vehicle, the predicted time period until the detected other road user will enter the virtual safety bubble includes displaying the predicted time period on a countdown timer.

12. The method of claim 10, wherein:
indicating, to the occupant of the parked vehicle, the first safety condition includes emitting a first audible sound within the parked vehicle;
indicating, to the occupant of the parked vehicle, the second safety condition includes emitting a second audible sound within the parked vehicle;
indicating, to the occupant of the parked vehicle, the third safety condition includes emitting a third audible sound within the parked vehicle; and
the first audible sound, the second audible sound, and the third audible sound are distinct from one another.

13. The method of claim 10, further comprising one of:
locking one or more doors of the parked vehicle by default and unlocking the one or more doors when one of the first safety condition and the second safety condition is in effect; and
locking the one or more doors of the parked vehicle when the third safety condition is in effect.

14. The method of claim 10, wherein indicating, to the occupant of the parked vehicle, the predicted time period until the detected other road user will enter the virtual safety bubble includes an audible countdown.

15. The method of claim 10, further comprising adjusting the predetermined time threshold based on one or more of:
detected traffic density; and
a measured duration required for occupants of the parked vehicle to exit the parked vehicle safely.

16. The method of claim 10, wherein the predicted time period until the detected other road user will enter the virtual safety bubble is based, at least in part, on one or more of:
signal phase and timing information for a traffic signal received over a network; and
position and movement data pertaining to the detected other road user received over a network from a traffic information system.

17. The method of claim 10, further comprising:
indicating, to the occupant of the parked vehicle, the third safety condition when a tracked speed of the detected other road user exceeds a predetermined speed threshold.

18. The method of claim 10, further comprising indicating to one or more other road users that a door of the parked vehicle is about to be opened, when one of the first safety condition and the second safety condition is in effect.

19. The method of claim 10, further comprising:
indicating, to the occupant of the parked vehicle, the first safety condition while the detected other road user is stationary within the virtual safety bubble.

20. The method of claim 19, further comprising:
indicating, to the occupant of the parked vehicle, the third safety condition, when the detected other road user begins moving.
